(19) United States
(12) Patent Application Publication
(10) Pub. No.: US 2004/0070284 A1
(43) Pub. Date: Apr. 15, 2004

(54) Marine electrical system protector

(76) Inventor: Robert Donald Lee, Fort Myers, FL (US)

Correspondence Address: ROBERT D. LEE, 11211 LAZY ACRES LANE, FORT MYERS, FL, 33905, US

(21) Appl. No.: 10/270,896

(22) Filed: Oct. 15, 2002

(51) Int. Cl. H02J 9/00

(52) U.S. Cl. 307/150

(57) ABSTRACT

The marine electrical system protector is a device which will not allow voltage above or below acceptable values to enter the ships' electrical system.

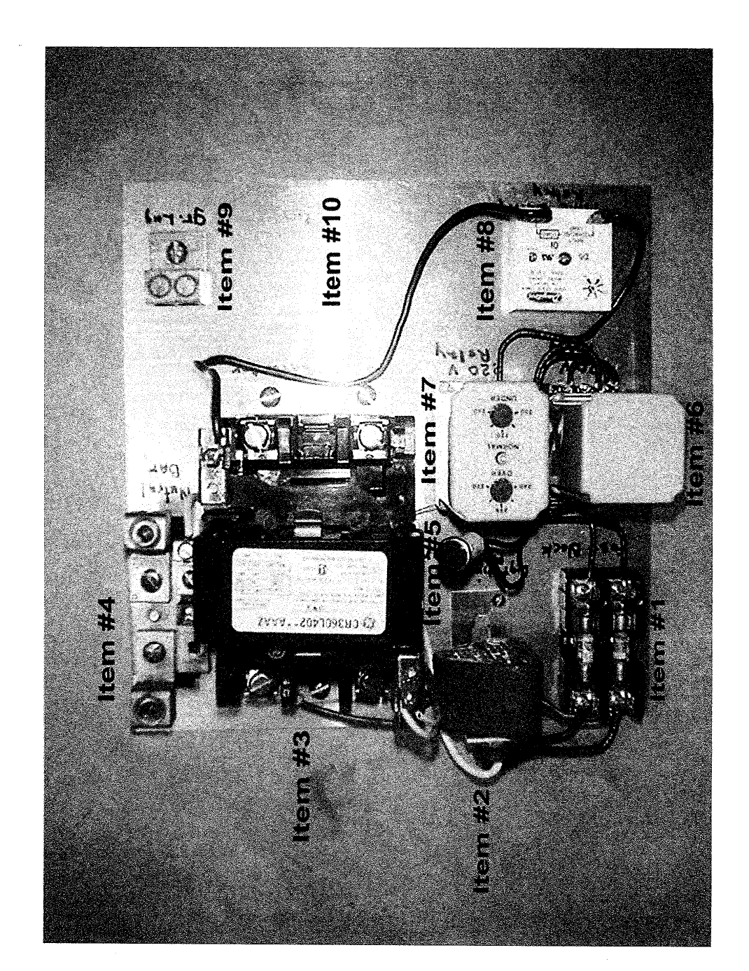

### BACKGROUND OF INVENTION

A problem has existed in the marine electrical systems of marinas and private docks for many years. This is the loss of electrical continuity from the shore power outlet due to highly corrosive environment. When the neutral conductor becomes highly resistive or completely open on a 120/240 volt 4 wire shore power system, the 120 volt appliances are subjected to voltages as high as 240 volts, which can cause burn outs and possible fires. Also the 220 volt equipment can be damaged by low voltage (brown out) conditions due to highly resistive connections in the shore power devices (i/e/50 amp 120/240 4 wire receptacles and panels. After many occurrences in our marina, I was asked to build a device to protect a yacht from these problems.

### SUMMARY

This invention constantly monitors incoming voltages from the shore power cord and plug system. The 120 volt monitor has a window of acceptable voltage from 100 volts to 130 volts. If voltage goes above or below the window of acceptable voltage, the relay will open the control circuit contacts whereupon the main contactor will open immediately, disconnecting the vessels' electrical system. When proper voltage is restored, the relay will close. A time-delay relay will be energized. After 2 minute time delay is completed, the main contactor will close and vessel power will be restored. 2 minute delay allows time for refrigeration and air conditioning units to equalize pressures before restart.

The 220 volt monitoring relay constantly monitors the ungrounded 220 volt lines from the shore power to ships power panel. Whereupon a voltage drop or rise, below or above the windows acceptable voltages, the relay will open the control contacts, whereupon the main contactor will open immediately, disconnecting the vessels' electrical system.

Upon return to acceptable voltages, the 220 volt relay will close the control contacts, energizing the time delay which will close in 2 minutes and close the main contactor to restore ships power. The device has a residual grade surge suppressor in the circuit also.

Two 3 amp control fuses are installed in fuse holder for protection of control circuit equipment. A green pilot light is installed ahead of the time delay relay, signaling the closure of monitoring relay. Two minutes after green light is on, the main contactor will close, and ships power will be restored.

### DETAILED DESCRIPTION

The Marine Electrical System Protector is a device comprised of the assembly of different parts to achieve the end result of electrical protection of a vessels electrical systems

Item #10: The aluminum base is ⅛″ thick×12 inches square.

Item #9: The mechanical lug is double hole #4 wire size to allow 2 #6 wires to be connected. Incoming and outgoing equipment ground wires.

Item #8: Dayton time delay relay, adjustable. This times the closure of main contactor

Item #7: Time Mark #2681 relay 220 monitor. This monitoring relay opens control circuit upon high or low voltage, opening main contactor.

Item #6: Time Mark #268 relay 120 volt monitor. This relay monitors the neutral conductor. This relay will open the control circuit if voltage is above or below the acceptable window. Main contactor will open.

Item #5: Green pilot light 120 volt. This pilot light, when on, indicates normal power is present and system is operating. Main contactor is closed or in the timing sequence (2 minutes) to closing.

Item #4: Isolated neutral bar. This connection terminal is for the connection of incoming and outgoing neutral conductors as well as control circuit neutral. Connector is isolated form aluminum backing plate.

Item #3: Main contactor. This General Electric contactor is rated at 60 amps, 240 volts. A 120 volt control coil closes the contactor when control system is in normal mode. Contactor opens when control circuit is open.

Item #2: Residential style surge suppressor. The surge suppresor collects spikes and drains spike voltage to the systems neutral.

Item #1: 2 Fuse block. The fuse block accepts fuses to protect the control circuit only. Fuses to be 3 amp rated.

Optional Equipment:

#1 Volt meters —220 volt and 120 volt in cover

#2 Auxiliary contacts for 120 volt emergency light or alarm circuitry.

#3 Red indicator light between neutral and ground terminals indicating voltage existing between neutral and ground.

Unit to be hand wired at first point of connection before the ships power panel.

1. What I claim as my invention is the complete protection of ships' electrical system from over voltages, under voltages and loss of neutral conductor.
